(19) United States
(12) Patent Application Publication
(10) Pub. No.: US 2026/0017686 A1
(43) Pub. Date: Jan. 15, 2026

(54) PROPERTY VALUATION USING HISTORICAL DATA

(71) Applicant: Quantarium Group, LLC, Bellevue, WA (US)

(72) Inventors: Andrei T. Aron, Woodinville, WA (US); Petru Cociorva, Redmond, WA (US); Adrian Fanaru, Sammamish, WA (US); Ioan Smintina, Kirkland, WA (US)

(21) Appl. No.: 18/771,027

(22) Filed: Jul. 12, 2024

(51) Int. Cl. G06Q 30/0201; G06Q 30/0204; G06Q 50/16

(52) U.S. Cl. CPC G06Q 30/0206; G06Q 30/0205; G06Q 50/16

(57) ABSTRACT

Systems and methods are disclosed for property valuation using historical data. In certain embodiments, a processor may be configured to identify pairs of similar property sales in historical property sale records, determine geographic sectors corresponding to locations of properties involved in the similar property sales, assign edge weights between the geographic sectors based on a number of pairs of similar property sales involving the geographic sectors in the historical property sale records, perform clustering of the geographic sectors based on the edge weights, and define a price-linked neighborhood of geographic sectors based on the clustering.

### TECHNICAL FIELD

Various embodiments of the present technology generally relate to computer and software systems and services, and in particular to systems and methods for the accurate valuation and appraisal of target properties based on comparable properties.

### SUMMARY

In certain embodiments, a method may comprise executing a property valuation operation via a computing system, including identifying pairs of similar property sales in historical property sale records, determining geographic sectors corresponding to locations of properties involved in the similar property sales, assigning edge weights between the geographic sectors based on a number of pairs of similar property sales involving the geographic sectors in the historical property sale records, and generating a set of recent sales of properties comparable to a target property based on the edge weights.

In certain embodiments, a memory device may store instructions that, when executed, cause a processor to execute a property valuation operation via a computing system, including identify pairs of similar property sales in historical property sale records, determine geographic sectors corresponding to locations of properties involved in the similar property sales, assign edge weights between the geographic sectors based on a number of pairs of similar property sales involving the geographic sectors in the historical property sale records, perform clustering of the geographic sectors based on the edge weights, and define a price-linked neighborhood of geographic sectors based on the clustering.

In certain embodiments, an apparatus may comprise a processor and a memory device storing instructions that cause the processor to identify pairs of similar property sales in historical property sale records, determine geographic sectors corresponding to locations of properties involved in the similar property sales, and assign edge weights between the geographic sectors based on a number of pairs of similar property sales involving the geographic sectors in the historical property sale records. The processor may further receive a selection identifying a target property, identify a target geographic sector including the target property, and generate a heatmap of geographic sectors based on the edge weights between the target geographic sector and other geographic sectors, including depict geographic sectors having higher edge weights as hotter, and depict geographic sectors having lower edge weights as colder.

### BRIEF DESCRIPTION OF THE DRAWINGS

FIG. 1 is a diagram of an example system configured to perform property valuation using historical data, in accordance with certain embodiments of the present disclosure;

FIG. 2 depicts an example data table for property valuation using historical data, in accordance with certain embodiments of the present disclosure;

FIG. 3 depicts an example display of a system for property valuation using historical data, in accordance with certain embodiments of the present disclosure;

FIG. 4 depicts a flowchart of an example method for property valuation using historical data, in accordance with certain embodiments of the present disclosure;

FIG. 5 depicts a flowchart of an example method for property valuation using historical data, in accordance with certain embodiments of the present disclosure;

FIG. 6 depicts a flowchart of an example method for property valuation using historical data, in accordance with certain embodiments of the present disclosure;

FIG. 7 depicts a flowchart of an example method for property valuation using historical data, in accordance with certain embodiments of the present disclosure; and

FIG. 8 is a diagram of an example system configured for property valuation using historical data, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

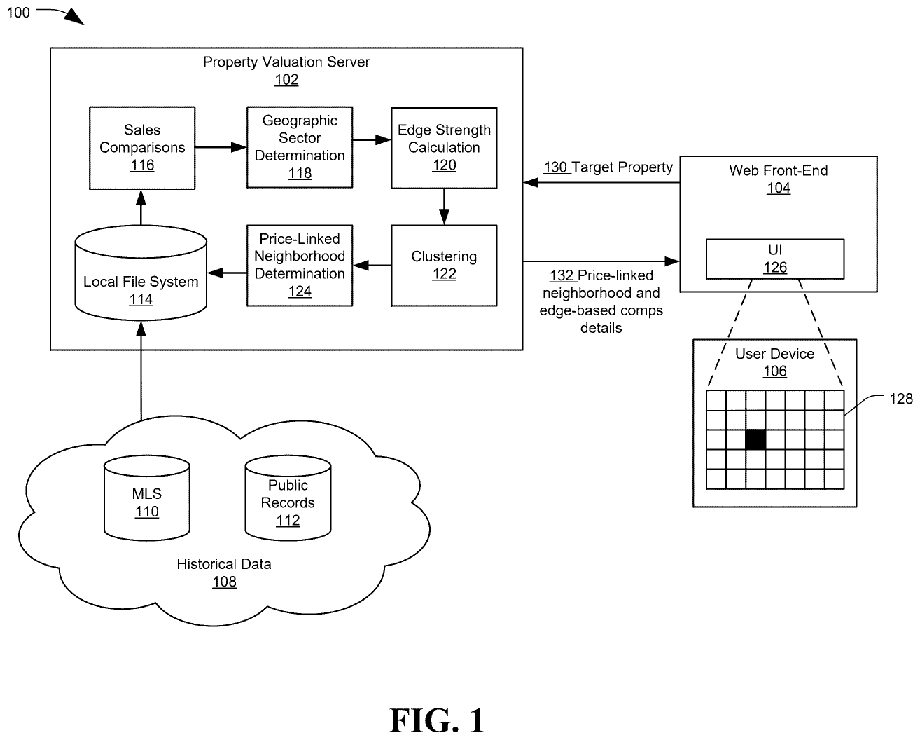

FIG. 1 depicts an example system 100 configured to perform property valuation using historical data, in accordance with certain embodiments of the present disclosure. In particular, system 100 provides an example set of elements for obtaining historical property sale records, and using the records to provide accurate property valuation estimates for use by appraisers, property buyers or sellers, or other users. System 100 may include a property valuation server 102, a web front-end 104, a user device 106, and one or more historical data record sources 108. Property valuation server 102, web front-end 104, user device 106, historical data sources 108, or any of their sub-components, may each be implemented via one or more computing systems, servers, or other processing devices, data storage or memory devices, or other computing apparatuses. The computing systems may implement functional modules to perform the operations described herein. In some embodiments, the elements of system 100 may include cloud computing modules, such as cloud servers configured to host and implement computational pods for performing the described operations. The systems may communicate over one or more network connections, either wired or wireless, to provide and receive data.

Property valuation and appraisal may be an important practice for various real estate purposes, including property sales, financing, taxation, and other applications. Properties may include single family homes, apartments, retail spaces, empty lots, or other properties. Property valuation may be based upon market demand; however, demand for property can vary significantly based on a multitude of factors, including timeframe, sales trends, property location, property size, school and taxing districts, and any number of considerations regarding improvements on the land. For example, a home's square footage, view, updates, age, and other factors may have a significant impact on a property's market value. Accordingly, property valuation may rely on identifying sales of comparable properties, or “comps”, and extrapolating a property value of the target property based on how it compares to the comps.

One of the greatest challenges in real estate valuation, be it via automated valuation models (AVMs) or manual appraisal, may be the definition of the neighborhood boundary for looking at comparable sales. Geographic neighborhood polygons may not provide a good solution because they don't always represent similar properties, and sometimes the geographic neighborhoods are too large or too small. Similarly, merely using a radius around a selected or target property may provide uneven results. Geographic or range-based areas may not be homogenous or isotropic when it comes to property sales and values. For example, homes having a same size and improvements may have different values despite being nearby, for example due to differences in school district, neighborhood, home-owners associations (HOA), elevation and view, or other factors. Ideally, a data-driven, functional neighborhood may be preferred, where the functional “neighborhood” may be based on properties that price similarly and share in market fluctuations.

Accordingly, proposed herein in may be systems and methods of defining price-linked neighborhood boundaries and highly relevant comps by looking at long-term, historical sales of similar properties (e.g., spanning ten, twenty, thirty, or more years). The process may first involve identifying pairs of similar houses or other properties, defined by having sold in close time-proximity (e.g., within a month of each other), at similar prices, and with similar parameters such as surface area, land, number of bedrooms, bathrooms, and garages, and property condition. Every pair of such sales over time may be recorded as an edge counter between their two geographic locations. Once all pairs are counted, the edges may provide a geographic graph, with varying degrees of edge strength (e.g., given by the number of sale pairs between any two regions). This graph can then be clustered into highly connected regions. These regions can then become the functional, price-linked neighborhoods. Accordingly, this method may allow for the definition of functional neighborhoods based on similar price behavior identified from long-term historical sales records. In some examples, a list of most similar comps for a target property can be generated even without performing any clustering, based on the computed edge strengths between the target property region and other regions with potential comps.

In the embodiment of system 100, the property valuation server 102 may be configured to process long-term historical data, identify pairs of similar property sales, compute edge strengths, and determine functional neighborhoods and relevant comps based on the computed edges. The property valuation server 102 may automatically perform historical data analysis (e.g., searching records, generating edge values, determining functional neighborhoods, etc.), may perform the historical data analysis in response to an instruction from an operator (e.g., an administrator of property valuation server 102), in response to a request initiated via a user device 106 accessing a web front-end 104 for the property valuation server 102, or according to other triggers. Historical data analysis may be performed via batch processing, in order to process the large volumes of data more efficiently. The property valuation server 102 may include a local file system 114, sales comparison module 116, geographic sector determination module 118, edge strength calculation module 120, clustering module 122, and price-linked neighborhood determination module 124.

Web front-end 104 may include a website, mobile application, or other interface via which a user may access the services and operations of property valuation server 102. For example, a user may access the web front-end 104 to identify a target property 130, and receive information 132 on a functional price-linked neighborhood for the target property, highly relevant edge-based comps, or other property valuation data and features. The web front-end 104 may include a user interface (UI) module 126, such as a graphical user interface (GUI) via which a user may input data, interact with maps and tables, and receive data.

User device 106 may include any computing device via which a user may access the UI 126 of the web front-end 104. For example, user device 106 may include a smartphone or tablet, a personal computer or laptop, a set-top box or smart television, or other computing terminal. The user device 106 may have input functionality such as a touchscreen, mouse, keyboard, pointer device, or other input systems, as well as one or more output or displays, such as a visual display screen 128.

Historical data sources 108 may include one or more data repositories of property sales records. The historical data may include any combination of private databases and publicly-available databases that are accessible by property valuation server 102, such as due to being hosted on the internet with access available for free or for a fee. Example historical data sources 108 may include an MLS (multiple listing source) database 110, and a public records database 112. Public records databases 112 may be available for various states, cities, counties, municipalities, or other regions, and may include property records that are recorded to establish chain of title to various properties within the region.

In an example embodiment, property valuation server 102 may obtain long-term historical sales records from historical data sources 108, and may store the records to a local file system 114. Local file system 114 may be a private or proprietary database or memory device, and may not necessarily be locally situated with any other component of property valuation server 102. Property valuation server 102 may be configured to retrieve the historical records automatically (e.g., based on being configured to periodically check pre-configured web addresses for records not already in local file system 114), or the data may be stored or uploaded to local file system 114 by an operator or administrator. The historical sales records may include information such as a property address or legal description, date of sale, and sale price. The sales records may also include additional details that may be used to better compare properties, such as square footage of a plot of land, square footage of any buildings on the property, a number of bedrooms and bathrooms, a year the building was built, a number of floors, whether a home includes a garage or pool, how recently or well-updated a home was, or other factors that may be relevant to property valuation and appraisal.

The records in the local file system 114 may be used by the sales comparisons module 116 to identify pairs of sales that are similar or comparable. The sales comparisons module 116 may be configured to apply various filters to identify similar sales, such as excluding properties with greater than 20% difference in land area or 10% difference in square footage of a home, requiring both properties to have or lack a garage, etc. Sales may also be required to be within a selected time period, such as within three months of each other. In some embodiments, the sales comparisons module 116 may only evaluate sales within a selected range of each other (e.g., fifteen miles, or within a same county). In some embodiments, the sales comparisons module 116 may identify pairs of sales within a range of similarities, such that extremely similar properties are given a higher “score” or “value” than pairs of sales that are less similar. Pairs of sales that the sales comparisons module 116 identifies as similar may be stored to local file system 114, provided to geographic sector determination module 118, or both.

Geographic sector determination module 118 may receive the sale pairs data, and may determine a particular geographic sector in which each property in the sale pair is located. For example, the property valuation server 102 may break down geographic regions or maps into sectors, such as rectangular boxes. Each sector may be relatively small, such as a few hundred or thousand feet per side. Based on the address, geographic location (e.g., latitude and longitude coordinates), legal property description, or other location-identifying information, the geographic sector determination module 118 may identify which geographic sector each property within a property sale pair is situated. If both properties are within a same geographic sector, the pair set may be discarded as not providing useful location-matching data. The geographic sector determination module 118 may add indicators of the identified geographic sectors for each property to the property sale pair data, and may store it to local file system 114, provide ti to edge strength calculation module 120, or both.

Edge strength calculation module 120 may be configured to determine how functionally related or price-linked each geographic sector is, based on the historical sale pairs. Accordingly, each geographic sector may be represented as a vertex on a graph, and how functionally related any two geographic sectors are may be represented as a strength or weight of an edge between the vertices. The edge strength calculation module 120 may generate or maintain a graph, table, or chart storing values of the weights on edges between geographic sectors. When a pair of geographic sectors corresponding to a historical sale pair is received from the geographic sector determination module 118, the edge strength calculation module 120 may increase the strength, value, or weight of the edge between those sectors. The edge weight may be calculated by a simple addition of a fixed value for each identified sale pair (e.g., operating as a counter with “1” added for each identified sale pair), or may include more complex evaluations. For example, if the sales comparisons module 116 scores sale pairs based on how similar the properties were, then more similar properties may increase the edge weight more than less similar properties. More recent sales may be given a higher value for edge weights than older sales, to account for potential changes to neighborhoods over time. Sale pair weights may be averaged, or outliers may be discarded. Other embodiments are also possible. Once the edge weights have been calculated, the edge strength calculation module 120 may store them to local file system 114, provide them to clustering module 122, or both.

Clustering module 122 may perform cluster analysis or clustering computations for geographic sectors based on the edge weights. Clustering may include grouping the geographic sectors in such a way that more similar sectors are grouped (called a cluster), with the similarity of the sectors based on how price-linked or functionally related they are. The clustering results may be stored to local file system 114, provided to price-linked neighborhood determination module 124, or both.

The price-linked neighborhood determination module 124 may use the clustering results to identify functional “neighborhoods” of related geographic sectors in a map. The neighborhood determination module 124 may generate or identify geographic boundaries around related geographic sectors to delineate the functional neighborhoods that share similar pricing and market trends for property valuation. The price-linked neighborhoods may be displayed on a map, such as on a screen 128 of user device 106 via web front-end 104. The neighborhoods may be identified by boundary lines, different coloration, heatmaps, or other methods.

Identified functional neighborhoods may be calculated as “fixed” based on their similarities to one another, regardless of a selected target property 130, so that all users may see the same neighborhood groupings. In other embodiments, the functional neighborhoods may be different for each target property 130, with some geographic sectors potentially being included in different neighborhoods based on having borderline similarity to multiple different sectors. For example, a clustering algorithm may be applied to an entire dataset (e.g., by clustering module 122), which may produce a set of pre-defined neighborhoods grouped by overall similarity, regardless of a target property 130 selected for comparison. In another example, the boundaries of a price-linked neighborhood may depend on a selected target property 130. For example, if a user selects a property in a geographic sector H8, the price-linked neighborhood determination module 124 may use the edge strength information between the geographic sector of the target property and other sectors to identify the other geographic sectors most similar to H8, and may show properties within those sectors that would make current valuable comps (e.g., properties within the identified price-linked geographic sectors that are most similar to the target property that have sold most recently), via feedback 132. Another user that specified a target property in P4 may see a different price-linked neighborhood, which may include some of the same geographic sectors as were suggested for the H8 property. A “similarity threshold” or “edge-weight threshold” may be set for edge weights between a selected target geographic sector and other sectors to determine which sectors to include in the functional neighborhood, which, depending on how conservative the threshold is, may generate a smaller or larger neighborhood around the subject.

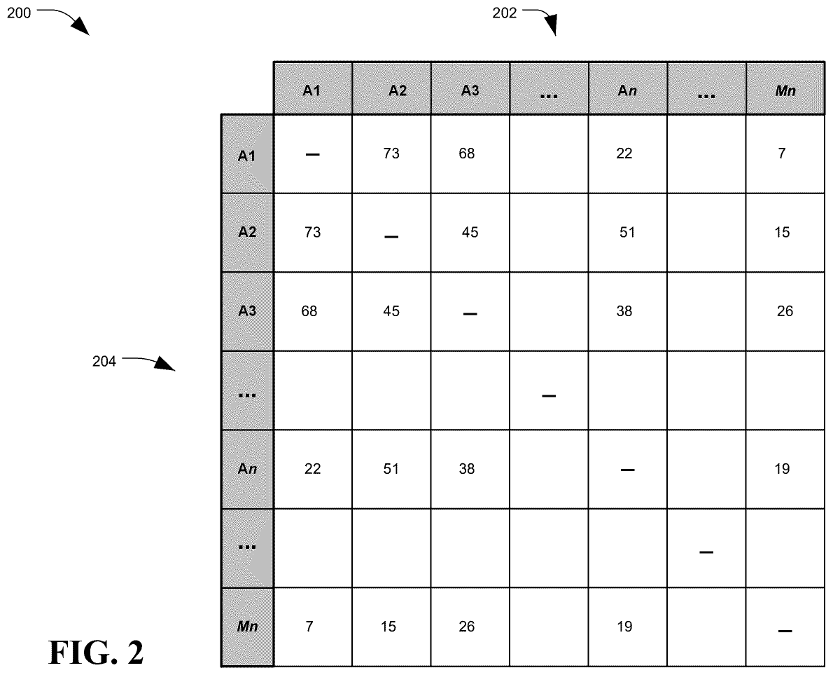

Further, the price-linked neighborhood determination module 124 may identify comparable properties for a target property based on the determined neighborhoods or edge weights, and generate lists or highlight the comps on a map. The price-linked neighborhood determination module 124 may store the determined functional neighborhoods, comp determinations, or other data to local file system 114, provide them to web front-end 104 as results 132, or otherwise manage the data. An example table illustrating edge weights is described in regard to FIG. 2.

FIG. 2 depicts an example data table 200 for property valuation using historical data, in accordance with certain embodiments of the present disclosure. In particular, table 200 depicts an example data structure for representing edge weights, values, or strengths between geographic sectors on a map. The table 200 may be generated or populated by a property valuation server or service 102, such as via edge strength calculation module 120 of FIG. 1.

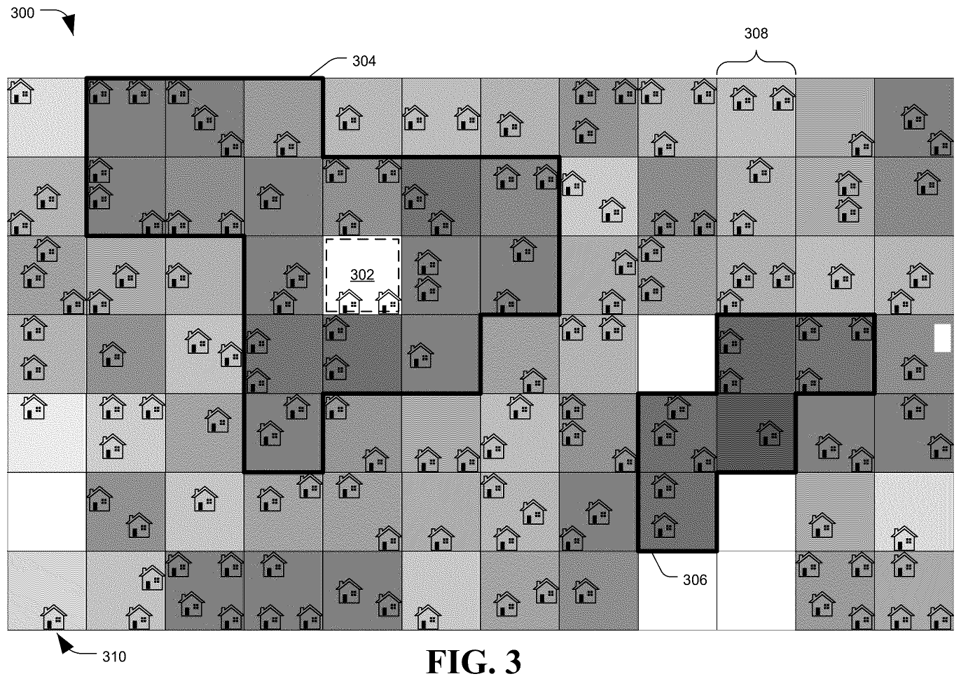

Table 200 may include a plurality of columns 202 and row 204, with each column and row corresponding to a geographic sector on a map. Here, the geographic sectors may be represented by alphanumeric values, such as A1, A2, . . . . An, . . . . Mn. Where a column intersects with a row on the table may be a value representing the edge weight between those sectors. For example, the intersection of A1 and A3 may be the edge value 68. The edge value may be a counter, with the value representing the number of similar sale pairs between those geographic sectors in the long-term historical data records, or the number of similar sale pairs divided by the number of total sale pairs, or based on another algorithm. In another example, the edge weight may be a function of the number and similarity between identified sale pairs in the records, the recency of the sale pairs, or other factors. The higher the value or weight of an edge between geographical sectors, the more closely those sectors may be linked from a valuation or pricing perspective. The edge values may therefore be used for clustering of geographic sectors to identify price-linked neighborhoods, to identify most-relevant comps to a target comp, to train AVMs to produce more accurate results due to highly-related and relevant data inputs, or for other applications. An example map generated based on the edge weights is discussed in regard to FIG. 3.

FIG. 3 depicts an example display 300 of a system for property valuation using historical data, in accordance with certain embodiments of the present disclosure. In particular, display 300 may depict a map of properties segmented into geographic sectors, with example heatmap and price-linked neighborhood boundaries represented. The display 300 may be generated by property valuation server or service 102, and depicted on a screen 128 of user device 106 via web front-end 104 of FIG. 1, for example.

Each square 308 on the display may represent a geographic sector. Within each sector 308 may be zero or more properties, with each property represented as a house 310. The size of the geographic sectors 308 may be set by an operator or administrator of the property valuation service 102, set by a user, or otherwise selected. The geographic sector 308 size may be a universal value, or may be different for different regions. For example, the use geographic sectors 308 to identify price-linked areas may depend on a minimum density of properties within an average sector. Accordingly, sector 308 size may be best set to a larger size when property density is low, and to a smaller size when property density is high.

A property valuation service 102 may determine edge strengths between the sectors 308 based on historical records of similar property sale pairs between the sectors. These edge weight values may be applied in a variety of ways to identify price-linked neighborhoods, to identify useful comps in valuing a target property 302, for training valuation models, and other applications.

In an example implementation, the property valuation service 102 may perform clustering on the edge strengths, and use the clustering results to identify price-linked neighborhoods. For example, the property valuation service 102 may employ an algorithm that looks for groups of geographic sectors having shared edge strengths over a selected threshold value. The property valuation service 102 may fill in or outline the identified price-linked or functional neighborhoods on the map, such as a first neighborhood 304 and a second neighborhood 306. In some embodiments, the functional neighborhoods may be calculated for an entire map based on the edge strength values, without regard to any target property 302. In other embodiments, a user may identify a target property 302, and the property valuation service 102 may calculate a neighborhood that includes geographic sectors most similar to the geographic sector in which the target property 302 is located.

In some examples, price-linked neighborhoods may be contiguous, such that all included sectors are connected with no islands. For example, functional neighborhood 304 may be one contiguous neighborhood, and functional neighborhood 306 may be a separate contiguous neighborhood. In other embodiments, a single neighborhood may include more than one isolated island of geographic sectors, to account for situations where remote sectors are highly price-linked despite not being geographically adjacent. For example, geographic sectors 304 and geographic sectors 306 may both be considered part of the price-linked neighborhood most similar to selected target property 302.

In another example application of edge weights, the property valuation service 102 may generate a heatmap based on a selected target property 302. For example, a user may select a target property for valuation, and the property valuation service may determine that the property is located at geographic sector 302. The property valuation service 102 may then retrieve the edge weights between the target geographic sector 302 and the other geographic sectors on the map 300. The edge weights may be visually represented on the display 300 as a color or opacity gradation, or other heatmap representation. For example, the higher the edge weight value between the target sector 302 and a given sector, the more red or darker the given sector may appear, while the lower the edge weight, the more blue or lighter the given sector may appear. An example heatmap for target sector 302 is depicted on display 300 using shading gradation, where darker sectors indicate a stronger or higher edge weight with the target sector 302. A user may utilize the heatmap to search for the most relevant available comps, by prioritizing similar comps in the hottest sectors. In some embodiments, the property valuation service 102 may provide users with tools to draw neighborhood outlines 304 or 306, and a user may choose where to draw the outlines based on the heatmap results. The user may then search for comps that fall within the drawn neighborhood outlines.

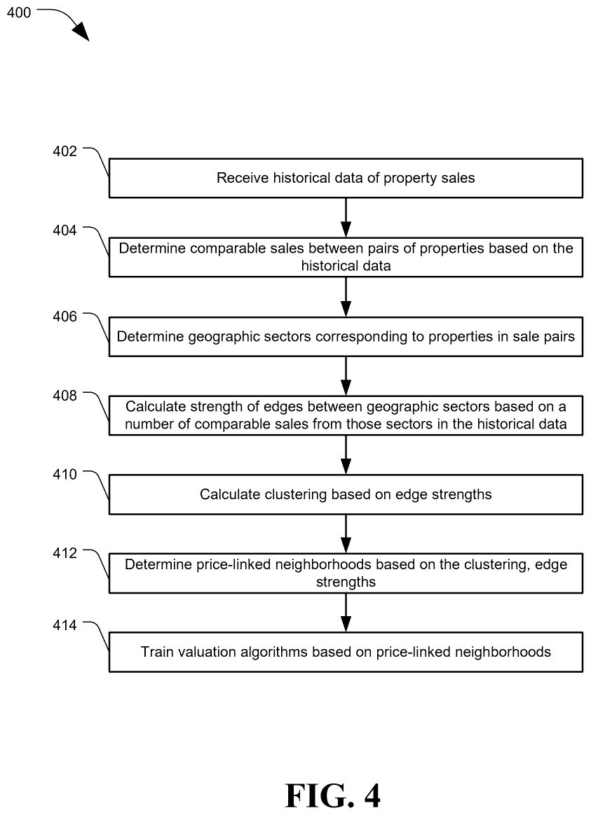

In some embodiments, a user may specify a target property, and the property valuation service 102 may identify the corresponding target geographic sector 302. The property valuation service 102 may identify similar comps to the target property, identify their corresponding geographic sectors, and identify the edge weights between the target sector and the comps' geographic sectors. The property valuation service may then provide the comps to the user in a list sorted according to the edge weights for the geographic sector of each comp. Accordingly, a user may focus on the highest-listed comps as likely to be the most relevant to the target property, based on historical sales data. An example method of using long-term historical sales data in property valuation is described in regard to FIG. 4.

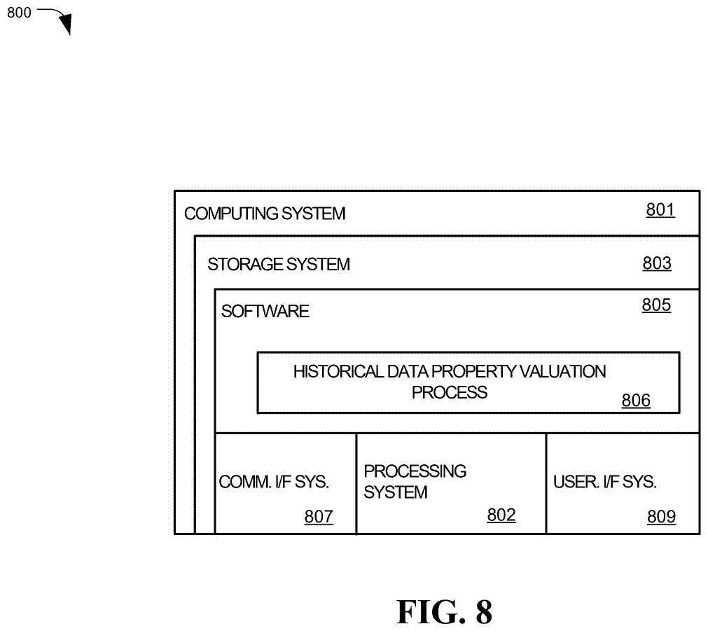

FIG. 4 depicts a flowchart 400 of an example method for property valuation using historical data, in accordance with certain embodiments of the present disclosure. In particular, flowchart 400 provides an example process for using long-term historical sales data to generate price-linked neighborhoods. The method of FIG. 4 may be implemented via systems and computing devices such as those depicted in FIG. 1 and FIG. 8.

The method may include receiving historical data of property sales, at 402. The historical sales data may be obtained from public or private databases, such as public land records and MLS databases. A property valuation system may be configured to access and download records from these sources, for example according to a schedule, or the data may be uploaded to a property valuation system. The historical data may include a legal description or location of the property, sale date or timeframe, sale price, and potentially identifying information about the property, such as land area, square footage, number of bedrooms, bathrooms, garages, or other factors that may be used to identify similar property sales.

At 404, the method may include determining comparable sales between pairs of properties based on the historical data. For example, the method may include comparing land size, square footage, or other attributes available to determine whether properties are similar for the purposes of property valuation. Determining comparable sales may also include limiting the evaluation to sales that occurred within a selected period of time, such as three months or six months. Other limitations may be considered, such as how far apart the properties are from each other.

The method may include determining geographic sectors corresponding to properties in identified similar sale pairs, at 406. For example, a map of a region may be broken down into geographic sectors, such as squares of land that may be several hundred feet per side, and properties may be considered to be within a geographic sector (e.g., based on which sector the majority of the property falls within, or which sector the corresponding address falls).

At 408, the method may include calculating or assigning edge weights, strengths, or values between geographic sectors based on a number of comparable sales from those sectors identified in the historical data. In an example embodiment, an edge weight between sectors may be increased by a set value for each identified similar sale pair in the historical records. In some embodiments, more similar sale pairs may increase the edge weight more than less similar sale pairs.

Based on the edge weights, the method may include grouping geographic sectors using clustering, at 410. The clustering may allow a property valuation service to group geographic sectors that share consistent or similar pricing patterns over time, as reflected in the long-term historical records and corresponding edge weights. At 412, the method may include determining price-linked or functional neighborhoods based on the clustering, based on the edge strengths, or both. For example, functional neighborhoods may be grouped by clustering algorithms applied to a data set, so that the neighborhoods are set regardless of a selected target property. In another example, functional neighborhoods may be defined based on a selected edge strength threshold between a target property (and its associated geographic sector) and other sectors. What edge strengths or weights are sufficient to warrant grouping geographic sectors together may be modified or selected in various ways. For example, a machine learning algorithm (e.g., using neural networks) may be trained based on labeled inputs identifying which connections between sectors are good and which connections are bad, and then the trained artificial intelligence (AI) system may apply the learned grouping criteria. In another example, a manual slider or input may allow for manual selection of a “similarity threshold” for grouping sectors, wherein a low threshold may result in larger price-linked neighborhoods, and a higher threshold may result in smaller neighborhoods. Once a neighborhood has been determined, a property valuation system may display the neighborhood on a map, potentially with a polygon or geometric border around the one or more determined price-linked neighborhoods, or with different colors applied to different neighborhoods.

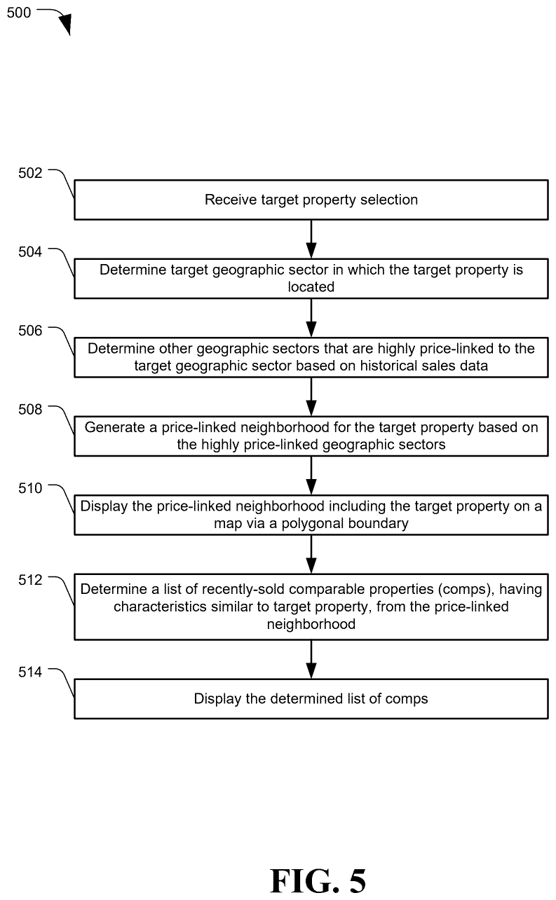

In some embodiments, once price-linked neighborhoods have been determined, an automatic valuation model (AVM) algorithm may be trained based on the neighborhoods, at 414. As the neighborhoods are known to be highly price-linked based on the historical sales records, an AVM trained based on the pre-established functional neighborhoods should be able to produce highly coherent and accurate algorithms and pricing estimates. The historical data-based approach may address a difficulty in the art of training AVMs based on geographic neighborhoods or property radiuses that may not share consistent pricing trends. For example, an AVM may be trained on comparable properties, in order to compute a similarity score between each comp and the subject property. Various factors may be used to determine the similarity score between properties, including a distance between them. Instead of or in addition to distance, AVM training can use the geographic inter-sector score computed as described herein, providing more accurate similarity scores. The similarity score may be used for both comp selection via a threshold, and for weighing each comp's contribution to the final valuation. A method for generating price-linked neighborhoods based on a target property is described in regard to FIG. 5.

FIG. 5 depicts a flowchart 500 of an example method for property valuation using historical data, in accordance with certain embodiments of the present disclosure. In particular, flowchart 500 provides an example process for using long-term historical sales data and a selected target property to generate a price-linked neighborhood. The method may presume that historical data has already been obtained, and potentially that edge weight values have been assigned. The method of FIG. 5 may be implemented via systems and computing devices such as those depicted in FIG. 1 and FIG. 8.

At 502, the method may include receiving a target property selection. A target property selection may be received from a user, such as via a web interface of a property valuation system. The user may select a property with a mouse or other pointer from a map, may enter a property address into a search bar, or otherwise designate the target property.

The method may include determining a target geographic sector in which the target property is located, at 504. The property valuation system may use a property legal description, address, or coordinates to map the property to a specific geographic sector of a map. Based on the determined target sector, the method may include determining other geographic sectors that are highly price-linked to the target geographic sector, based on historical sales data (e.g., based on assigned edge weights between the sectors), at 506.

At 508, the method may include generating a price-linked neighborhood for the target property based on the highly price-linked geographic sectors. In some examples, the determined neighborhood may include a contiguous group of geographic sectors including the target property that have the highest edge weight affinity with the target geographic sector. In another example, the price-linked neighborhood may include one or more non-contiguous groups of geographic sectors having high edge weight affinity with the target sector, which may result in “islands” of sectors that are not physically connected to the target sector but that share strong pricing trends. The method may include displaying the price-linked neighborhood that includes the target property on a map, such as via a polygonal boundary, highlighting, or color scheme, at 510. The map may be displayed on a screen of a user device.

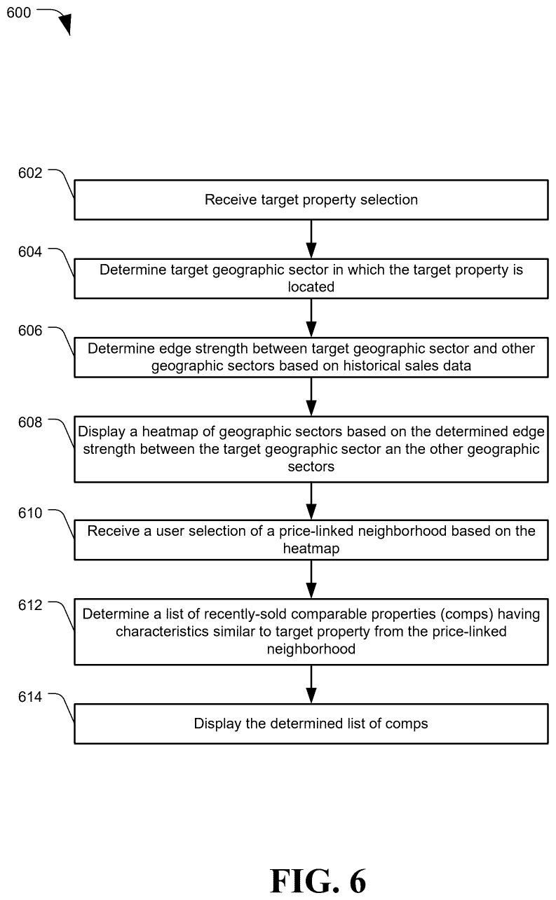

At 512, the method may include determining a list of recently-sold comparable properties, having characteristics similar to the target property, from the determined price-linked neighborhood. Comps selected from the determined price-linked neighborhood may be more likely to be relevant for valuation of the target property than comps outside of the neighborhood. The determined list of comps may be displayed to the user, at 514. The user may use the list of comps to value the target property, such as by analyzing the comps in more details to evaluate how they compare to the target property. A method of generating a heatmap based on historical sales data is described in regard to FIG. 6.

FIG. 6 depicts a flowchart 600 of an example method for property valuation using historical data, in accordance with certain embodiments of the present disclosure. In particular, flowchart 600 provides an example process for using long-term historical sales data and a selected target property to generate a heatmap of price-related geographic sectors. The method may presume that historical data has already been obtained, and potentially that edge weight values have been assigned. The method of FIG. 6 may be implemented via systems and computing devices such as those depicted in FIG. 1 and FIG. 8.

At 602, the method may include receiving a target property selection, such as from a user interface as described in regard to FIG. 5. The method may include determining a target geographic sector in which the target property is located, at 604. At 606, the method may include determining or assigning edge strength values between the target geographic sector and other geographic sectors based on historical sales data.

At 608, the method may include generating and displaying a heatmap of geographic sectors based on the edge weights between the target geographic sector and the other geographic sectors. For example, sectors having a higher edge weight with the target sector may be displayed as more red (or another color), or more dark (e.g., via shading or opacity), while sectors having lower edge weights may be displayed as more blue, or more light. The heatmap display may allow a user to determine at a glance which areas are most similar, from a property valuation perspective, to the area in which the target property is located.

At 610, the method may include receiving a user selection of a price-linked neighborhood based on the heatmap. For example, a web front-end user interface of the property valuation service may allow a user to draw a border, or select geographic tiles, to include in a price-linked neighborhood with the target property, or to use to search for relevant comps. The heatmap may allow the user to determine how price-linked they wish the neighborhood to be by selecting one or more regions including a desired pricing history similarity to the target sector.

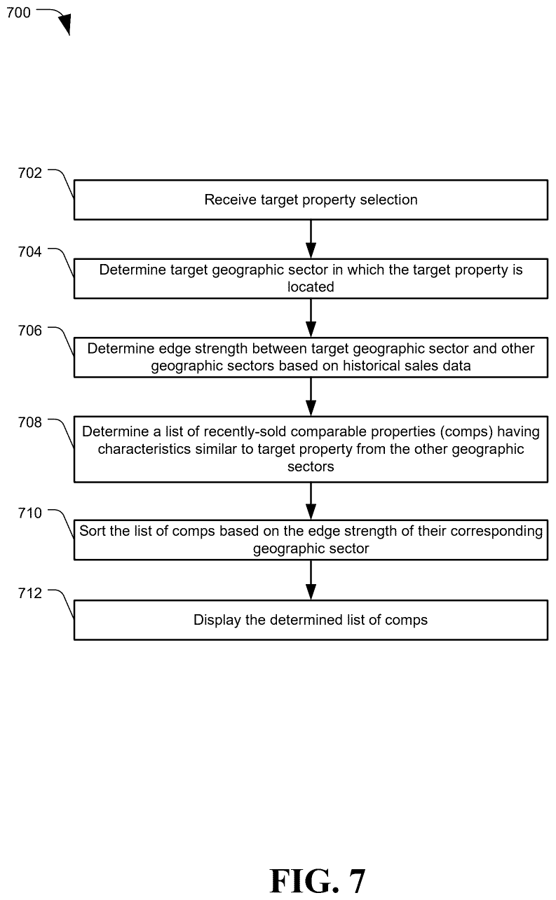

At 612, the method may include determining a list of recently-sold comparable properties, having similar characteristics to the target property, from the price-linked neighborhood selected by the user. The list of recently-sold properties from the selected neighborhood may be displayed to the user, for example via highlighting the properties on the map or presenting a list of properties. In some examples, the user may adjust the boundaries or sectors included in the neighborhood, and the list of comparable properties may be updated accordingly. A method of presenting a list of relevant comps based on historical sales records is described in regard to FIG. 7.

FIG. 7 depicts a flowchart 700 of an example method for property valuation using historical data, in accordance with certain embodiments of the present disclosure. In particular, flowchart 700 provides an example process for using long-term historical sales data and a selected target property to generate a list of most relevant comps. The method may presume that historical data has already been obtained, and potentially that edge weight values have been assigned. The method of FIG. 7 may be implemented via systems and computing devices such as those depicted in FIG. 1 and FIG. 8.

At 702, the method may include receiving a target property selection, such as from a user interface. At 704, the method may include determining a target geographic sector in which the target property is located. Edge weights may be determined or assigned between the target geographic sector and other geographic sectors based on historical sales data, at 706. At 708, the method may include determining a list of recently sold comparable properties, having characteristics similar to the target property, from the other geographic sectors.

At 710, the method may include sorting the list of comps based on the edge strength or weight of their corresponding geographic sectors. For example, rather than limiting a search for comps to a particular price-linked neighborhood, the method may include identifying all comps within the edge-weighted geographic sectors. The list of comps may then be sorted according to the edge weight of its associated geographic sector. Comps having the highest corresponding edge weights may be placed at the top of the list, with comps having progressively lower edge weights being listed in descending order. At 712, the method may include displaying the determined list of comps, such as on a user interface to a user. The sorted list may allow a user to quickly identify which comps are likely to be most relevant based on historical data, and to take as few or as many comps from the top of the list as the user desires for use in valuing the target property. The comp list as provided herein may avoid presenting a graphical map to a user, as all uses of geographic sectors may be performed behind-the-scenes at the property valuation service. A non-map interface may be advantageous to a user on a small screen or operating within data limits. An example system configured for property valuation using historical data is described in regard to FIG. 8.

FIG. 8 is a diagram of an example system 800 configured to implement property valuation using historical data, in accordance with certain embodiments of the present disclosure. System 800 may be an example of an apparatus including a computing system 801 that is representative of any system or collection of systems in which the various processes, systems, programs, services, and scenarios disclosed herein may be implemented. For example, computing system 801 may be an example property valuation server 102, web front-end 104, user device 106, historical data sources 108, or any of the subcomponents depicted in system 100 of FIG. 1. Examples of computing system 801 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 801 may be implemented as a single apparatus, system, or device or may be implemented in a distributed manner as multiple apparatuses, systems, or devices. Computing system 801 may include, but is not limited to, processing system 802, storage system 803, software 805, communication interface system 807, and user interface system 809. Processing system 802 may be operatively coupled with storage system 803, communication interface system 807, and user interface system 809.

Processing system 802 may load and execute software 805 from storage system 803. Software 805 may include and implement historical data property valuation process 806, which may be representative of any of the operations for evaluating historical property sale data, identifying pairs of comparable property sales, assigning edge weights between geographic sectors, generating price-linked neighborhoods or heatmaps, training valuation models, and identifying relevant comps for a target property, as discussed with respect to the preceding figures. When executed by processing system 802, software 805 may direct processing system 802 to operate as described herein for at least the various processes, operational scenarios, and sequences discussed in the foregoing implementations. Computing system 801 may optionally include additional devices, features, or functionality not discussed for purposes of brevity.

In some embodiments, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 may include general purpose central processing units, graphical processing units, application specific processors, and logic devices, as well as any other type of processing device, combinations, or variations thereof.

Storage system 803 may comprise any memory device or computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including historical data property valuation process 806 among other functions) may be implemented in program instructions that may, when executed by processing system 802, direct processing system 802 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system as described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
executing a property valuation operation via a computing system, including:
identifying pairs of similar property sales in historical property sale records;
determining geographic sectors corresponding to locations of properties involved in the similar property sales;
assigning edge weights between the geographic sectors based on a number of pairs of similar property sales involving the geographic sectors in the historical property sale records; and
generating a set of recent sales of properties comparable to a target property based on the edge weights.

2. The method of claim 1 further comprising:
performing clustering of the geographic sectors based on the edge weights; and
defining a price-linked neighborhood of geographic sectors based on the clustering.

3. The method of claim 2 further comprising:
receiving a selection identifying the target property;
identifying a target geographic sector including the target property;
defining the price-linked neighborhood based on identifying the geographic sectors sharing highest edge weights with the target geographic sector; and
generating the set of recent sales based on properties comparable to the target property located within the price-linked neighborhood.

4. The method of claim 2 further comprising:
training an automated valuation model (AVM) using machine learning based on the price-linked neighborhood.

5. The method of claim 1 further comprising:
receiving a selection identifying the target property;
identifying a target geographic sector including the target property;
generating a heatmap of geographic sectors based on the edge weights between the target geographic sector and other geographic sectors, including:
depicting geographic sectors having higher edge weights as hotter; and
depicting geographic sectors having lower edge weights as colder.

6. The method of claim 5 further comprising:
providing a user interface to a user;
providing a tool, via the user interface, to enable the user to define a price-linked neighborhood based on the heatmap;
defining a price-linked neighborhood based on user input via the tool; and
generating the set of recent sales based on properties comparable to the target property located within the price-linked neighborhood.

7. The method of claim 1 further comprising:
sorting the set of recent sales of properties comparable to the target property based on the edge weights, wherein recent sales from geographic sectors sharing higher edge weights with a target geographic sector containing the target property are listed above recent sales from geographic sectors sharing lower edge weights with the target geographic sector; and
presenting a list of the sorted set of recent sales at a user interface.

8. The method of claim 1 further comprising:
dividing a map into the geographic sectors, wherein a size of the geographic sectors is set based on a density of properties on the map.

9. A memory device storing instructions that, when executed, cause a processor to:
execute a property valuation operation via a computing system, including:
identify pairs of similar property sales in historical property sale records;
determine geographic sectors corresponding to locations of properties involved in the similar property sales;
assign edge weights between the geographic sectors based on a number of pairs of similar property sales involving the geographic sectors in the historical property sale records;
perform clustering of the geographic sectors based on the edge weights; and
define a price-linked neighborhood of geographic sectors based on the clustering.

10. The memory device of claim 9 storing instructions that, when executed, cause the processor to further:
receive a selection identifying a target property;
identify a target geographic sector including the target property; and
generate a set of recent sales of properties comparable to a target property based on edge weight values between the target geographic sector and other geographic sectors.

11. The memory device of claim 10 storing instructions that, when executed, cause the processor to further:
sort the set of recent sales of properties comparable to the target property based on the edge weights, wherein recent sales from geographic sectors sharing higher edge weights with the target geographic sector are listed above recent sales from geographic sectors sharing lower edge weights with the target geographic sector; and
present a list of the sorted set of recent sales at a user interface.

12. The memory device of claim 9 storing instructions that, when executed, cause the processor to further:
receive a selection identifying a target property;
identify a target geographic sector including the target property;
define the price-linked neighborhood based on identifying geographic sectors sharing highest edge weights with the target geographic sector; and
generate a set of recent sales based on properties comparable to the target property located within the price-linked neighborhood.

13. The memory device of claim 9 storing instructions that, when executed, cause the processor to further:
train an automated valuation model (AVM) using machine learning based on the price-linked neighborhood.

14. The memory device of claim 9 storing instructions that, when executed, cause the processor to further:
receive a selection identifying a target property;
identify a target geographic sector including the target property;
generate a heatmap of geographic sectors based on the edge weights between the target geographic sector and other geographic sectors, including:
depict geographic sectors having higher edge weights as hotter; and
depict geographic sectors having lower edge weights as colder.

15. The memory device of claim 14 storing instructions that, when executed, cause the processor to further:
provide a user interface to a user;
provide a tool, via the user interface, to enable the user to define a price-linked neighborhood based on the heatmap;
define a user-selected price-linked neighborhood based on user input via the tool; and
generate a set of recent sales based on properties comparable to the target property located within the user-selected price-linked neighborhood.

16. An apparatus comprising:
a processor; and
a memory device storing instructions that cause the processor to:
identify pairs of similar property sales in historical property sale records;
determine geographic sectors corresponding to locations of properties involved in the similar property sales;
assign edge weights between the geographic sectors based on a number of pairs of similar property sales involving the geographic sectors in the historical property sale records;
receive a selection identifying a target property;
identify a target geographic sector including the target property;
generate a heatmap of geographic sectors based on the edge weights between the target geographic sector and other geographic sectors, including:
depict geographic sectors having higher edge weights as hotter; and
depict geographic sectors having lower edge weights as colder.

17. The apparatus of claim 16, further comprising the processor configured to execute the instructions to:
perform clustering of the geographic sectors based on the edge weights; and
define a price-linked neighborhood of geographic sectors based on the clustering.

18. The apparatus of claim 17, further comprising the processor configured to execute the instructions to:
define the price-linked neighborhood based on identifying geographic sectors sharing highest edge weights with the target geographic sector; and
generate a set of recent sales based on properties comparable to the target property located within the price-linked neighborhood.

19. The apparatus of claim 18, further comprising the processor configured to execute the instructions to:
sort the set of recent sales of properties comparable to the target property based on the edge weights, wherein recent sales from geographic sectors sharing higher edge weights with the target geographic sector are listed above recent sales from geographic sectors sharing lower edge weights with the target geographic sector; and
present a list of the sorted set of recent sales at a user interface.

20. The apparatus of claim 16, further comprising the processor configured to execute the instructions to:
provide a user interface to a user;
provide a tool, via the user interface, to enable the user to define a price-linked neighborhood based on the heatmap;
define a user-selected price-linked neighborhood based on user input via the tool; and
generate a set of recent sales based on properties comparable to the target property located within the user-selected price-linked neighborhood.
